(19) United States
(12) Patent Application Publication
(10) Pub. No.: US 2025/0144602 A1
(43) Pub. Date: May 8, 2025

(54) VISIBLE LIGHT RESPONSIVE PHOTOCATALYST

(71) Applicant: SHARP KABUSHIKI KAISHA, Sakai City (JP)

(72) Inventors: Ryota TANAKA, Sakai City (JP); Shinya Okazaki, Sakai City (JP); Keigo Mitamura, Sakai City (JP)

(21) Appl. No.: 18/938,520

(22) Filed: Nov. 6, 2024

(30) Foreign Application Priority Data
Nov. 7, 2023 (JP) 2023-190205
Oct. 18, 2024 (JP) 2024-184343

(51) Int. Cl. B01J 23/30; B01J 23/42; B01J 23/652; B01J 35/40

(52) U.S. Cl. CPC B01J 23/30; B01J 23/42; B01J 23/6527; B01J 35/40

(57) ABSTRACT

The visible light responsive photo catalyst of the disclosure includes at least one tungsten oxide particle and at least one co-catalyst particle supported on a surface of the tungsten oxide particle, in which 20% or more of the co-catalyst particles of a plurality (100 or more) of the co-catalyst particles each of whose primary particle diameter is measurable by an electron microscopic image of the visible light responsive photocatalyst are non-aggregates and each have a primary particle diameter from 6 nm to 20 nm.

### TECHNICAL FIELD

The disclosure relates to a visible light responsive photocatalyst.

### BACKGROUND ART

A photocatalyst in which platinum particles (Pt particles) are supported on a tungsten oxide particle is known (see, for example, PTL 1). Aggregates of a plurality of the platinum particles each having a primary particle diameter of about 5 nm are attached to the surface of the tungsten oxide particle.

### CITATION LIST

### Patent Literature

PTL 1: JP 2009-160566 A

### SUMMARY

### Technical Problem

In the known photocatalyst, aggregates of platinum particles are attached to a surface of the tungsten oxide particle, and thus an effect of separating a photoexcited electron and a hole by a co-catalyst on the tungsten oxide particle may be reduced, and photocatalytic activity may be reduced.

The disclosure has been made in view of such a circumstance, and provides a visible light responsive photocatalyst having high photocatalytic activity.

### Solution to Problem

The disclosure provides a visible light responsive photocatalyst including at least one tungsten oxide particle and at least one co-catalyst particle supported on a surface of the tungsten oxide particle, in which 20% or more of the co-catalyst particles of a plurality (100 or more) of the co-catalyst particles each of whose primary particle diameter is measurable by an electron microscopic image of the visible light responsive photocatalyst are non-aggregates and each have a primary particle diameter from 6 nm to 20 nm.

The disclosure also provides a visible light responsive photocatalyst in which an average primary particle diameter of a plurality of co-catalyst particles which are non-aggregates each of whose primary particle diameter is measurable by an electron microscopic image of the visible light responsive photocatalyst is from 6 nm to 20 nm. The disclosure also provides a visible light responsive photocatalyst in which 50% or more of the tungsten oxide particles of a plurality (100 or more) of the tungsten oxide particles each of whose aspect ratio (ratio (b/a) of a major axis b to a minor axis a of a primary particle) is calculable from an electron microscope image of the visible light responsive photocatalyst each have an aspect ratio from 1.3 to 10.

### Advantageous Effects of Disclosure

A visible light responsive photocatalyst of the disclosure has high photocatalytic activity.

### BRIEF DESCRIPTION OF DRAWINGS

FIGS. 1A and 1B are STEM images of a photocatalyst of Example 1, and FIG. 1C is a table showing primary particle diameters of seven Pt particles each of whose primary particle diameter can be measured in the images of FIGS. 1A and 1B.

FIGS. 2A and 2B are SEM images of the photocatalyst of Example 1.

FIG. 3 is a table showing a minor axis, a major axis, an aspect ratio, a peripheral length, an area, and a degree of circularity of respective 10 tungsten oxide particles each of whose primary particle diameter can be measured in the images of FIGS. 2A and 2B.

FIG. 4A is a graph showing a change in acetaldehyde residual ratio (%) in an acetaldehyde gas decomposition experiment conducted using the photocatalyst of Example 1, and FIG. 4B is a table showing acetaldehyde concentrations measured in this acetaldehyde gas decomposition experiment and a gas decomposition rate.

FIG. 5A is an STEM image of a photocatalyst of Example 2, and FIG. 5B is a table showing primary particle diameters of eight Pt particles each of whose primary particle diameter can be measured in the image of FIG. 5A.

FIGS. 6A and 6B are SEM images of the photocatalyst of Example 2.

FIG. 7 is a table showing a minor axis, a major axis, an aspect ratio, a peripheral length, an area, and a degree of circularity of respective 10 tungsten oxide particles each of whose primary particle diameter can be measured in the images of FIGS. 6A and 6B.

FIG. 8A is a graph showing a change in acetaldehyde residual ratio (%) in an acetaldehyde gas decomposition experiment conducted using the photocatalyst of Example 2, and FIG. 8B is a table showing acetaldehyde concentrations measured in this acetaldehyde gas decomposition experiment and a gas decomposition rate.

FIG. 9A is an STEM image of a photocatalyst of Example 3, and FIG. 9B is a table showing primary particle diameters of 11 Pt particles each of whose primary particle diameter can be measured in the image of FIG. 9A.

FIGS. 10A and 10B are SEM images of the photocatalyst of Example 3.

FIG. 11 is a table showing a minor axis, a major axis, an aspect ratio, a peripheral length, an area, and a degree of circularity of respective 10 tungsten oxide particles each of whose primary particle diameter can be measured in the images of FIGS. 10A and 10B.

FIG. 12A is a graph showing a change in acetaldehyde residual ratio (%) in an acetaldehyde gas decomposition experiment conducted using the photocatalyst of Example 3, and FIG. 12B is a table showing acetaldehyde concentrations measured in this acetaldehyde gas decomposition experiment and a gas decomposition rate.

FIG. 13A is an STEM image of a photocatalyst of Comparative Example 1, and FIG. 13B is a table showing primary particle diameters of five Pt particles each of whose primary particle diameter can be measured in the image of FIG. 13A.

FIGS. 14A and 14B are SEM images of the photocatalyst of Comparative Example 1.

FIG. 15 is a table showing a minor axis, a major axis, an aspect ratio, a peripheral length, an area, and a degree of circularity of respective 8 tungsten oxide particles, each of whose primary particle diameter can be measured in the images of FIGS. 14A and 14B.

FIG. 16A is a graph showing a change in acetaldehyde residual ratio (%) in an acetaldehyde gas decomposition experiment conducted using the photocatalyst of Comparative Example 1, and FIG. 16B is a table showing acetaldehyde concentrations measured in this acetaldehyde gas decomposition experiment and a gas decomposition rate.

### DESCRIPTION OF EMBODIMENTS

### First Embodiment

A visible light responsive photocatalyst of the present embodiment includes at least one tungsten oxide particle and at least one co-catalyst particle supported on a surface of the tungsten oxide particle, in which 20% or more of the co-catalyst particles of a plurality (100 or more) of the co-catalyst particles each of whose primary particle diameter can be measured by an electron microscopic image of the visible light responsive photocatalyst are non-aggregates and each have a primary particle diameter from 6 nm to 20 nm, or an average primary particle diameter of the plurality of co-catalyst particles which are non-aggregates each of whose primary particle diameter can be measured by an electron microscopic image of the visible light responsive photocatalyst is from 6 nm to 20 nm. In the present specification, the term “primary particle” means a particle of a minimum unit whose particle diameter can be measured by the electron microscope image. An aggregate of a plurality of the primary particles is a secondary particle. The primary particle may be a particle that does not constitute the secondary particle. In the present specification, the term “non-aggregate” means that a particle of a minimum unit whose shape can be measured by the electron microscope image is dispersed to such an extent that the particle does not come into contact with another particle or does not form a lump.

The visible light responsive photocatalyst is a photocatalyst which generates photocatalytic activity by receiving visible light, and includes a plurality of the tungsten oxide particles and the plurality of co-catalyst particles supported on the surfaces of the tungsten oxide particles. The visible light responsive photocatalyst may be in the form of powder, may be dispersed in a dispersion medium, or may be contained in a photocatalyst layer. For example, a glass fiber processed to ensure air permeability may be used to form a filter, and the photocatalyst may be supported on the filter to form a photocatalyst filter having the photocatalyst layer.

The tungsten oxide particle is a particle of tungsten trioxide (WO₃). Tungsten oxide may have a composition deviating from the stoichiometric composition as long as tungsten oxide has photocatalytic activity. The tungsten oxide content of the photocatalyst may be 90 wt % or more.

90% or more of the tungsten oxide particles of the plurality (100 or more) of tungsten oxide particles each of whose primary particle diameter can be measured by an electron microscopic image of the visible light responsive photocatalyst each can have a primary particle diameter from 5 nm to 400 nm. Examples of the electron microscope image include a scanning electron microscope (SEM) image, a transmission electron microscope (TEM) image, a scanning transmission electron microscope (STEM) image, and an element mapping image obtained by electron microscope energy dispersive X-ray spectroscopy (SEM-EDX, TEM-EDX, or the like) (the same applies to electron microscope images described later). The primary particle diameter of the tungsten oxide particle may be measured using image analysis software, or may be measured using a scale bar of the image. When the tungsten oxide particle has a major axis and a minor axis, the primary particle diameter of the tungsten oxide particle can be the major axis of the particle. The “plurality (100 or more) of tungsten oxide particles” are particles freely selected from particles whose primary particle diameters can be measured by a plurality of electron microscope images and entire outer periphery can be observed.

50% or more of the tungsten oxide particles of the plurality (100 or more) of tungsten oxide particles each of whose aspect ratio (ratio (b/a) of a major axis b to a minor axis a of a primary particle) can be calculated from the electron microscope image of the visible light responsive photocatalyst each can have an aspect ratio from 1.3 to 10. The aspect ratio of the tungsten oxide particle may be measured and calculated using image analysis software, or may be calculated from the primary particle diameter (major axis and minor axis) measured using a scale bar of the image. In addition, the “plurality (100 or more) of tungsten oxide particles” are particles freely selected from particles in which aspect ratios in the plurality of electron microscope images can be calculated or all the particles.

70% or more of the tungsten oxide particles of the plurality (100 or more) of tungsten oxide particles each of whose degree of circularity can be calculated from the electron microscope image of the visible light responsive photocatalyst each may have the degree of circularity from 0.2 to 0.8. The degree of circularity of the tungsten oxide particle may be measured and calculated using image analysis software, or may be measured and calculated using a scale bar of the image. The “plurality (100 or more) of tungsten oxide particles” are particles freely selected from particles in which degrees of circularity in a plurality of electron microscope images can be measured and entire outer periphery of the particles can be observed or all the particles. The degree of circularity is a value representing the likelihood of a circle, and the closer to 1, the closer to the circle. The degree of circularity can be calculated using an equation: degree of circularity=4π×(area)÷(peripheral length)².

The co-catalyst particle is a particle supported on the surface of the tungsten oxide particle, and specific examples include a metal particle containing platinum, a metal oxide particle containing platinum, a metal particle containing at least one of gold, silver, ruthenium, rhodium, iridium, and palladium, and a metal oxide particle containing at least one of gold, silver, ruthenium, rhodium, iridium, and palladium. In the visible light responsive photo catalyst, a mass ratio of the plurality of co-catalyst particles to the plurality of tungsten oxide particles is preferably from 0.01 wt % to 2.0 wt %.

20% or more of the co-catalyst particles of the plurality (100 or more) of co-catalyst particles each of whose primary particle diameter can be measured by an electron microscopic image of the visible light responsive type photocatalyst are non-aggregates and each have a primary particle diameter from 6 nm to 20 nm. The primary particle diameter of the co-catalyst particle may be measured using image analysis software, or may be measured using a scale bar of the image. When the co-catalyst particle has a major axis and a minor axis, the primary particle diameter of the co-catalyst particle can be the major axis of the particle. The “plurality (100 or more) of co-catalyst particles” are particles freely selected from particles in which primary particle diameters in a plurality of electron microscope images can be measured and entire outer periphery of the particles can be observed or all the particles.

50% or more of the co-catalyst particles of the plurality (10 or more or preferably 100 or more) of co-catalyst particles each of whose primary particle diameter can be measured by the electron microscope image of the visible light responsive photocatalyst are preferably not in contact with another co-catalyst particle. Whether the co-catalyst particle is in contact with another co-catalyst particle can be confirmed from the electron microscope image. The “plurality (10 or more) of co-catalyst particles” or the “plurality (100 or more) of co-catalyst particles” are particles freely selected from particles that can be determined whether they are in contact with another co-catalyst particle in the plurality of electron microscope images. The particles may be primary particles.

### Second Embodiment

The visible light responsive photocatalyst of the present embodiment includes a tungsten oxide particle and a plurality of co-catalyst particles supported on a surface of the tungsten oxide particle. 50% or more of the tungsten oxide particles of the plurality (100 or more) of tungsten oxide particles each of whose aspect ratio (ratio (b/a) of a major axis b to a minor axis a of a primary particle) can be calculated from the electron microscope image of the visible light responsive photocatalyst each have an aspect ratio from 1.3 to 10.

In addition, 70% or more of the tungsten oxide particles of the plurality (100 or more) of tungsten oxide particles each of whose degree of circularity can be calculated from the electron microscope image of the visible light responsive photocatalyst each preferably have the degree of circularity from 0.2 to 0.8.

The visible light responsive photocatalyst, the tungsten oxide particles, the co-catalyst particles, the aspect ratio, the degree of circularity, and the like have been described in the first embodiment, and will not be described here.

### Preparation of Photocatalyst of Example 1

### Pulverizing Step

Tungsten oxide powder (for details, WO₃, available from Kishida Chemical Co., Ltd.) was dispersed in ion-exchanged water using a bead mill (media stirring type wet pulverizing and dispersing machine “MS C50” available from NIPPON COKE & ENGINEERING CO., LTD.), and the tungsten oxide particles were primarily pulverized to obtain a dispersion liquid of tungsten oxide.

### Co-Catalyst Supporting Step

Hexachloroplatinum (VI) hexahydrate (available from Kishida Chemical Co., Ltd., solid content concentration: 98.5%) was dissolved in the dispersion liquid of tungsten oxide. The amount of hexachloroplatinum (VI) hexahydrate added was such that the content of elemental platinum was 0.1% by mass relative to the mass of the tungsten oxide particles (W-A) to be prepared. Subsequently, the dispersion liquid was heated at 100° C. to evaporate water. As a result, a lump of tungsten oxide supporting platinum was obtained.

### Preparation of Photocatalyst of Example 2

A dispersion liquid obtained by dispersing tungsten oxide powder (for details, WO₃, available from Kishida Chemical Co., Ltd.) in water was irradiated with ultrasonic waves. This dispersion liquid was centrifuged (1000 rpm) for 10 minutes using a centrifuge, and particles having a large particle diameter were precipitated to be separated and removed from the dispersion liquid. The obtained dispersion liquid was dried to obtain tungsten oxide powder. The tungsten oxide powder was dispersed in water, an aqueous solution of hexachloroplatinic acid was added to the prepared tungsten oxide dispersion liquid 40 mL so that Pt was 0.1 parts by mass relative to 100 parts by mass of the tungsten oxide particles, and isopropyl alcohol 5 ml was further added to the dispersion liquid. After the addition, the dispersion liquid was irradiated with visible light for 24 hours while being stirred. A blue LED was used as a light source. Thereafter, the dispersion liquid was dried at 80° C. to obtain a powdery Pt-supporting tungsten oxide photocatalyst.

### Preparation of Photocatalyst of Example 3

### Pulverizing Step

Tungsten oxide powder (for details, WO₃, available from Kishida Chemical Co., Ltd.) was dispersed in ion-exchanged water using a bead mill (media stirring type wet pulverizing and dispersing machine “MS C50” available from NIPPON COKE & ENGINEERING CO., LTD.), and the tungsten oxide particles were primarily pulverized to obtain a dispersion liquid of tungsten oxide.

### Co-Catalyst Supporting Step

An aqueous solution of hexachloroplatinic acid was added to the prepared tungsten oxide dispersion liquid 40 mL prepared in the pulverizing step so that Pt was 0.1 parts by mass relative to 100 parts by mass of the tungsten oxide particles, and isopropyl alcohol 5 ml was further added to the dispersion liquid. After the addition, the dispersion liquid was irradiated with visible light for 24 hours while being stirred. A blue LED was used as a light source. Thereafter, the dispersion liquid was dried at 80° C. to obtain a powdery Pt-supporting tungsten oxide photocatalyst.

### Preparation of Photocatalyst of Comparative Example 1

A dispersion liquid obtained by dispersing tungsten oxide powder (for details, WO₃, available from Kishida Chemical Co., Ltd.) in water was irradiated with ultrasonic waves. This dispersion liquid was centrifuged (1000 rpm) for 10 minutes using a centrifuge, and particles having a large particle diameter were precipitated to be separated and removed from the dispersion liquid. The obtained dispersion liquid was dried to obtain tungsten oxide powder.

Hexachloroplatinum (VI) hexahydrate (available from Kishida Chemical Co., Ltd., solid content concentration: 98.5%) was dissolved in the dispersion liquid obtained by dispersing this tungsten oxide powder in water. The amount of hexachloroplatinum (VI) hexahydrate added was such that the content of elemental platinum was 0.1% by mass relative to the mass of the tungsten oxide particles (W-A) to be prepared. Subsequently, the dispersion liquid was heated at 100° C. to evaporate water. As a result, a lump of tungsten oxide supporting platinum was obtained.

Electron Microscope Observation of Photocatalyst of Example 1 The photocatalyst of Example 1 was observed with a scanning electron microscope (SEM). After the photocatalyst was observed by SEM, the minor axis a, the major axis b, the aspect ratio (b/a), the peripheral length, the area, and the degree of circularity of respective tungsten oxide particles were measured and calculated using “A-zou kun” which is an image analysis application.

In addition, the photocatalyst of Example 1 was observed with a scanning transmission electron microscope (STEM), and the primary particle diameters of the Pt particles were measured from the photographed images.

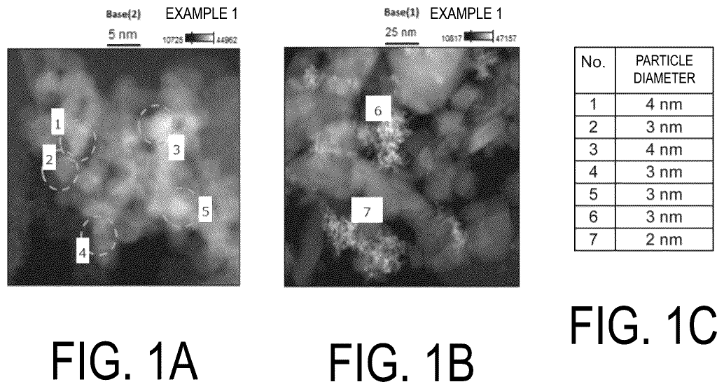

FIGS. 1A and 1B are STEM images of the photocatalyst of Example 1, and FIG. 1C is a table showing primary particle diameters of seven Pt particles each of whose primary particle diameter can be measured in the images of FIGS. 1A and 1B. As can be seen from FIGS. 1A and 1B, in the photocatalyst of Example 1, a plurality of Pt particles each having a primary particle diameter of 4 nm or smaller are aggregated (as secondary particles) and attached to the surface of the tungsten oxide particle.

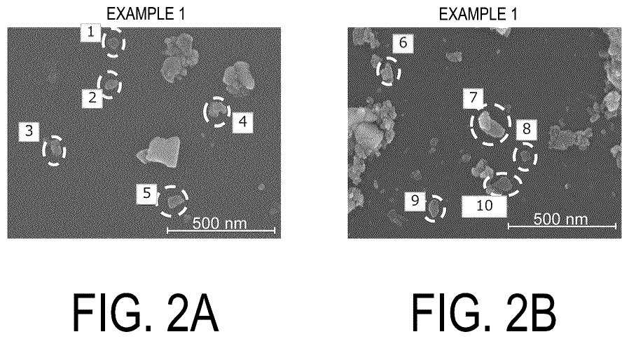

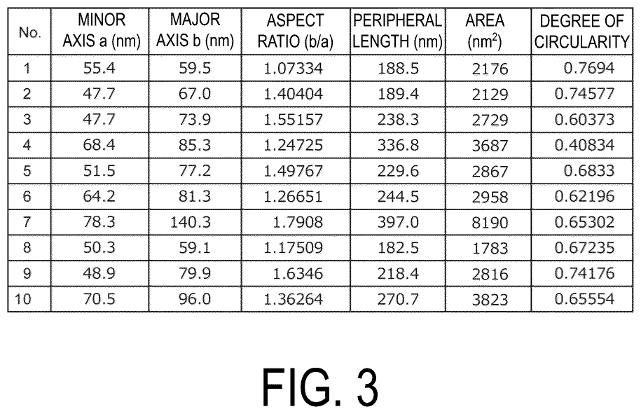

FIGS. 2A and 2B are SEM images of the photocatalyst of Example 1. FIG. 3 is a table showing a minor axis a (minimum width), a major axis b (maximum length), an aspect ratio (b/a), a peripheral length, an area, and a degree of circularity of respective 10 tungsten oxide particles each of whose primary particle diameter can be measured in the images of FIGS. 2A and 2B.

As shown in the table of FIG. 3, 60% of the tungsten oxide particles of the 10 tungsten oxide particles each had an aspect ratio of 1.3 or more.

The degree of circularity is a value representing the likelihood of a circle, and the closer to 1, the closer to the circle. The degree of circularity can be calculated using an equation: degree of circularity=4π×(area)÷(peripheral length)². The degrees of circularity of the 10 tungsten oxide particles in the images of FIGS. 2A and 2B were within the range from 0.2 to 0.8 as shown in the table of FIG. 3.

Acetaldehyde Gas Decomposition Experiment using Photocatalyst of Example 1 An acetaldehyde gas decomposition experiment was conducted using the photocatalyst of Example 1 to evaluate photocatalytic activity. Specifically, as the photocatalytic activity, decomposition activity of acetaldehyde (C₂H₄O) irradiated with visible light was evaluated. Specifically, a composition was placed in a dish (having a diameter of 60 mm) in such an amount that the mass of the photocatalyst contained in the composition was 0.05 g, and the composition was dried at 80° C. for 30 minutes. In this way, water in the composition was evaporated. A dish containing the dried composition was placed in a transparent gas bag of volume 5 L. The gas bag was filled with acetaldehyde gas (diluted with air) at a concentration 600 ppm.

Then, the composition in the gas bag was irradiated with light (central wave length: 450 nm, illuminance: 4500 1×). The acetaldehyde concentration in the gas bag was measured before the light irradiation (0.0 hours) and when 2 hours, 3 hours, and 4 hours have elapsed from the start of the light irradiation. For the measurement of the acetaldehyde concentration, a gas detection tube for acetaldehyde (“92” available from GASTEC CORPORATION) was used. The gas decomposition rate was calculated using the following equation.

$$gas decomposition rate = ( LN value of measurement value of {C}_{2} {H}_{4} O concentration at 2 hours - LN value of measurement value of {C}_{2} {H}_{4} O concentration at 4 hours ) \div 2 \qquad Equation$$

The higher the photocatalytic activity, the greater the gas decomposition rate. The LN value cannot be calculated when the concentration is 0, and thus the gas decomposition rate was calculated on the assumption that the concentration is 0.2 ppm, which is the minimum detectable amount of the detection tube used.

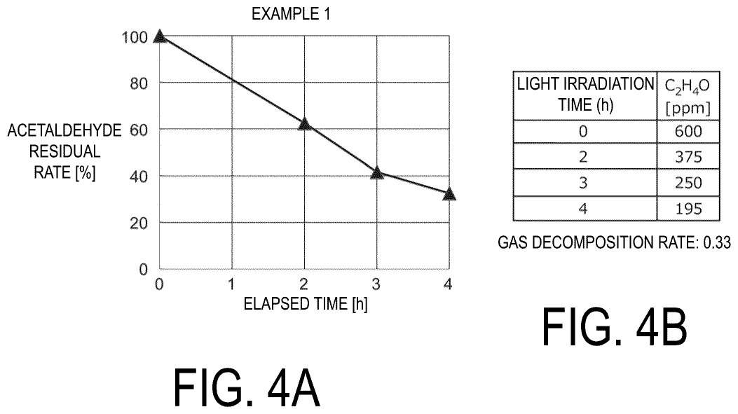

FIG. 4A is a graph showing a change in acetaldehyde residual ratio (%) in an acetaldehyde gas decomposition experiment conducted using the photocatalyst of Example 1, and FIG. 4B shows a gas decomposition rate calculated using the table showing acetaldehyde concentrations measured in this acetaldehyde gas decomposition experiment and the above equation.

In this experiment, as shown in FIG. 4B, the acetaldehyde gas concentration after light irradiation for 4 hours was 195 ppm, and the gas decomposition rate was 0.33. Thus, it was found that the photocatalyst of Example 1 had excellent photocatalytic activity.

### Electron Microscope Observation of Photocatalyst of Example 2

The photocatalyst of Example 2 was observed with a scanning electron microscope (SEM). After the photocatalyst was observed with SEM, the minor axis a, the major axis b, the aspect ratio (b/a), the peripheral length, the area, and the degree of circularity of respective tungsten oxide particles were measured and calculated using “A-zou kun” which is an image analysis application.

In addition, the photocatalyst of Example 2 was observed with a scanning transmission electron microscope (STEM), and the primary particle diameters of the Pt particles were measured from the photographed images.

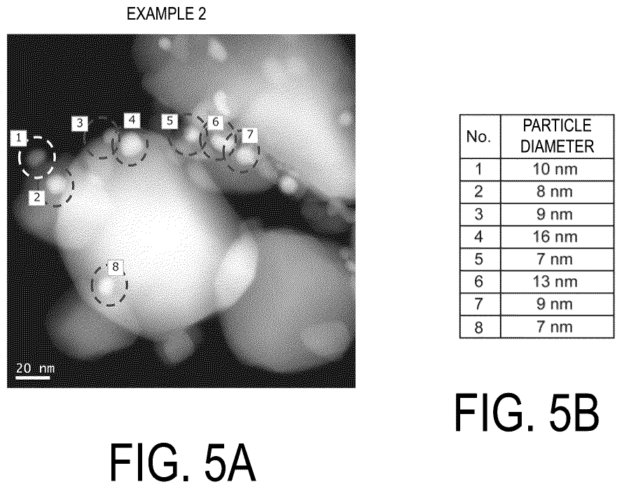

FIG. 5A is an STEM image of a photocatalyst of Example 2, and FIG. 5B is a table showing primary particle diameters of eight Pt particles each of whose primary particle diameter can be measured in the image of FIG. 5A. In the image of FIG. 5A, all of the primary particle diameters of the eight Pt particles attached to the tungsten oxide particle were 7 nm or more. In addition, each Pt particle does not appear to be in contact with another Pt particle.

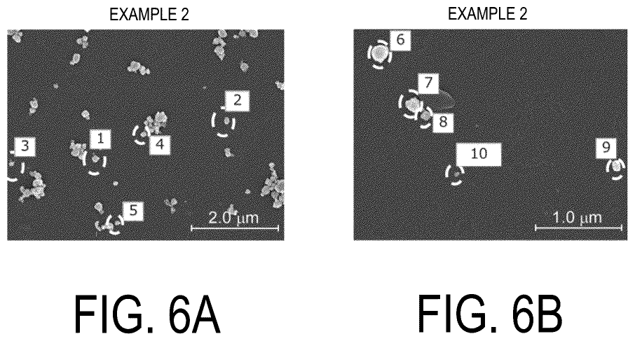

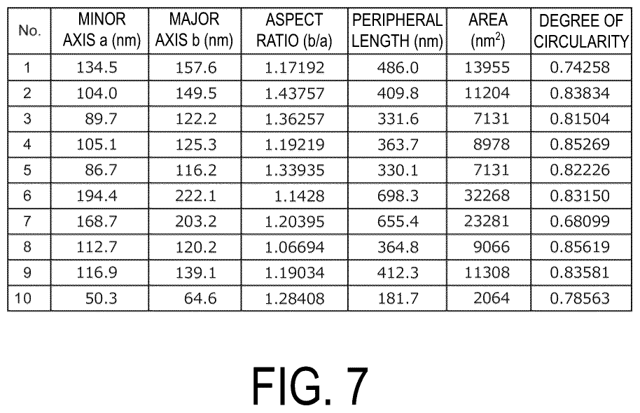

FIGS. 6A and 6B are SEM images of the photocatalyst of Example 2. FIG. 7 is a table showing a minor axis a (minimum width), a major axis b (maximum length), an aspect ratio (b/a), a peripheral length, an area, and a degree of circularity of respective 10 tungsten oxide particles each of whose primary particle diameter can be measured in the images of FIGS. 6A and 6B.

In the images, as shown in the table of FIG. 7, 70% of the tungsten oxide particles of 10 tungsten oxide particles each had an aspect ratio of 1.3 or less, and 70% of the tungsten oxide particles each had the degree of circularity more than 0.8.

Acetaldehyde Gas Decomposition Experiment using Photocatalyst of Example 2 An acetaldehyde gas decomposition experiment was conducted using the photocatalyst of Example 2 to evaluate the photocatalytic activity. The experimental method and the calculation method of the gas decomposition rate were the same as those of the acetaldehyde gas decomposition experiment using the photocatalyst of Example 1.

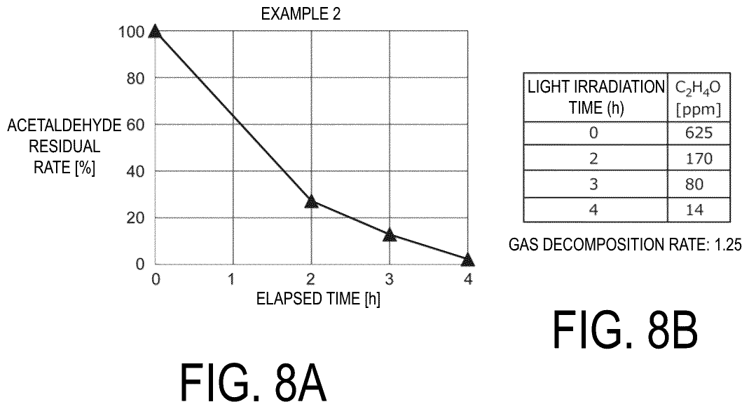

FIG. 8A is a graph showing a change in acetaldehyde residual ratio (%) in an acetaldehyde gas decomposition experiment conducted using the photocatalyst of Example 2, and FIG. 8B shows a gas decomposition rate calculated using the table showing acetaldehyde concentrations measured in this acetaldehyde gas decomposition experiment and the above equation.

In this experiment, as shown in FIG. 8B, the acetaldehyde gas concentration after light irradiation for 4 hours was 14 ppm, and the gas decomposition rate was 1.25. Thus, it was found that the photocatalyst of Example 2 had excellent photocatalytic activity.

Electron microscope observation of the photocatalyst of Example 3 The photocatalyst of Example 3 was observed with a scanning electron microscope (SEM). After the photocatalyst was observed with SEM, the minor axis a, the major axis b, the aspect ratio (b/a), the peripheral length, the area, and the degree of circularity of respective tungsten oxide particles were measured and calculated using “A-zou kun” which is an image analysis application.

In addition, the photocatalyst of Example 3 was observed with a scanning transmission electron microscope (STEM), and the primary particle diameters of the Pt particles were measured from the photographed images.

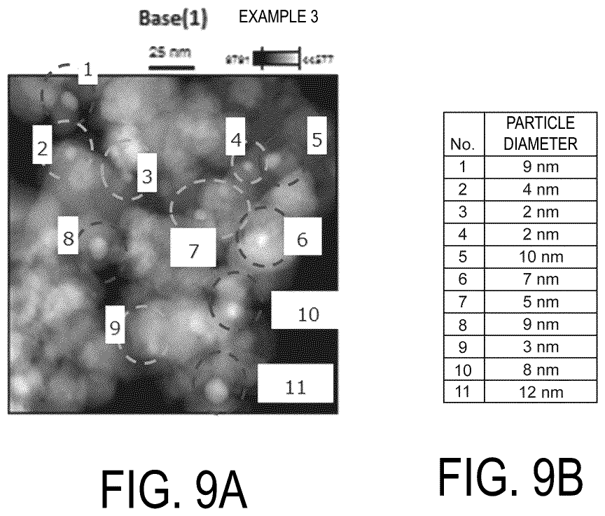

FIG. 9A is an STEM image of a photocatalyst of Example 3, and FIG. 9B is a table showing primary particle diameters of 11 Pt particles each of whose primary particle diameter can be measured in the image of FIG. 9A. In the image of FIG. 9A, the primary particle diameters of 6 (54%) Pt particles of the 11 Pt particles attached to the tungsten oxide particle were respectively 6 nm or more. In addition, each Pt particle does not appear to be in contact with another Pt particle.

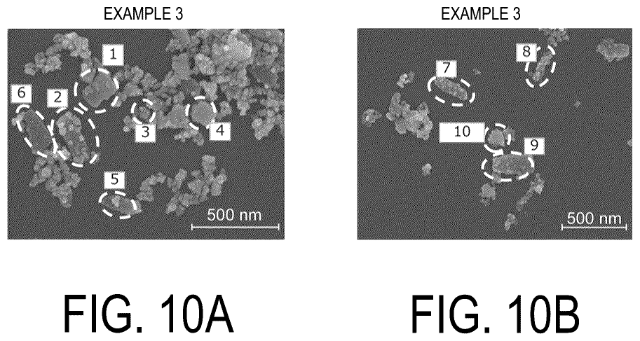

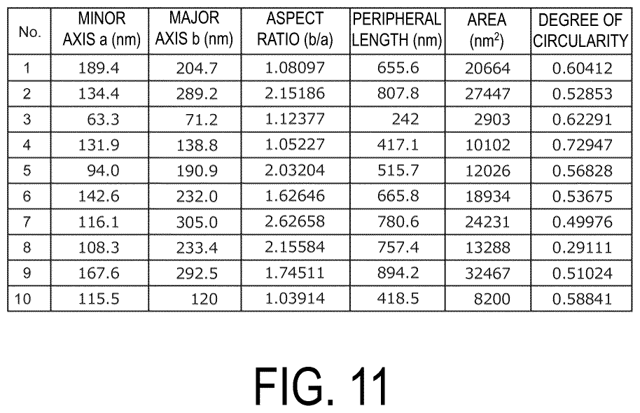

FIGS. 10A and 10B are SEM images of the photocatalyst of Example 3. FIG. 11 is a table showing a minor axis a (minimum width), a major axis b (maximum length), an aspect ratio (b/a), a peripheral length, an area, and a degree of circularity of respective 10 tungsten oxide particles each of whose primary particle diameter can be measured in the images of FIGS. 10A and 10B.

In the images, as shown in the table of FIG. 11, 60% of the tungsten oxide particles of the 10 tungsten oxide particles each had an aspect ratio of 1.5 or more, and all of the 10 tungsten oxide particles each had the degree of circularity from 0.2 to 0.8.

Acetaldehyde Gas Decomposition Experiment using Photocatalyst of Example 3 An acetaldehyde gas decomposition experiment was conducted using the photocatalyst of Example 3 to evaluate the photocatalytic activity. The experimental method and the calculation method of the gas decomposition rate were the same as those of the acetaldehyde gas decomposition experiment using the photocatalyst of Example 1.

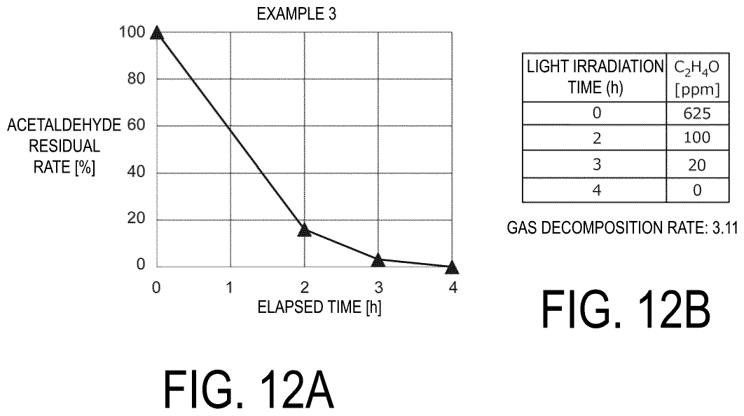

FIG. 12A is a graph showing a change in acetaldehyde residual ratio (%) in an acetaldehyde gas decomposition experiment conducted using the photocatalyst of Example 3, and FIG. 12B shows a gas decomposition rate calculated using the table showing acetaldehyde concentrations measured in this acetaldehyde gas decomposition experiment and the above equation.

In this experiment, as shown in FIG. 12B, the acetaldehyde gas concentration after light irradiation for 4 hours was 0 ppm, and the gas decomposition rate was 3.11. Thus, it was found that the photocatalyst of Example 3 had excellent photocatalytic activity.

Electron Microscope Observation of Photocatalyst of Comparative Example 1 The photocatalyst of Comparative Example 1 was observed with a scanning electron microscope (SEM). After the photocatalyst was observed with SEM, the minor axis a, the major axis b, the aspect ratio (b/a), the peripheral length, the area, and the degree of circularity of respective tungsten oxide particles were measured and calculated using “A-zou kun” which is an image analysis application.

In addition, the photocatalyst of Comparative Example 1 was observed with a scanning transmission electron microscope (STEM), and the primary particle diameters of the Pt particles were measured from the photographed images.

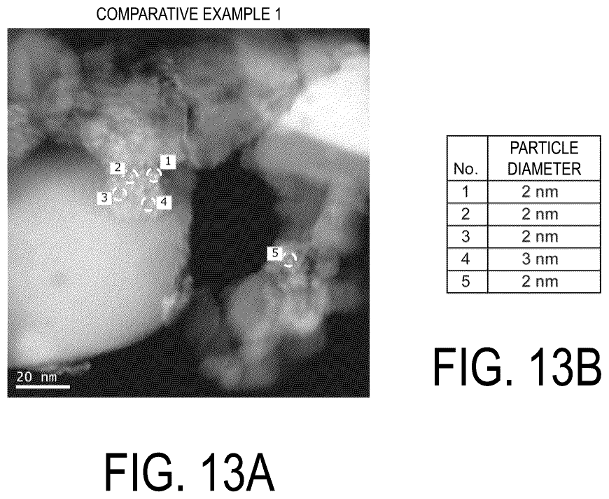

FIG. 13A is an STEM image of a photocatalyst of Comparative Example 1, and FIG. 13B is a table showing primary particle diameters of five Pt particles each of whose primary particle diameter can be measured in the image of FIG. 13A. As can be seen from FIG. 13A, in the photocatalyst of Comparative Example 1, a plurality of Pt particles each having a primary particle diameter of 3 nm or smaller are aggregated (as secondary particles) and attached to the surface of the tungsten oxide particle.

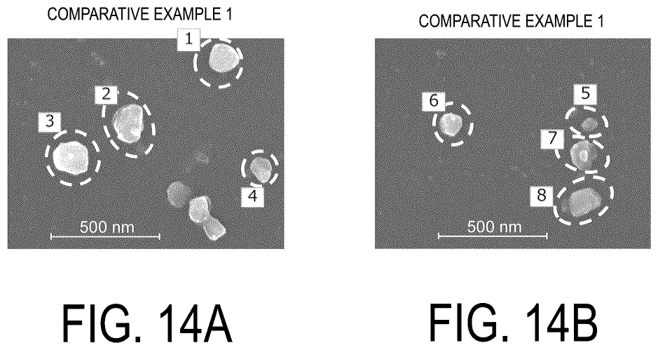

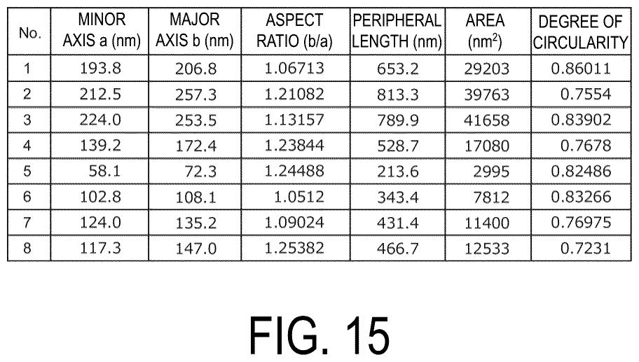

FIGS. 14A and 14B are SEM images of the photocatalyst of Comparative Example 1. FIG. 15 is a table showing a minor axis a (minimum width), a major axis b (maximum length), an aspect ratio (b/a), a peripheral length, an area, and a degree of circularity of respective 8 tungsten oxide particles each of whose primary particle diameter can be measured in the images of FIGS. 14A and 14B.

In the images, as shown in the table of FIG. 15, all of 8 tungsten oxide particles each had an aspect ratio less than 1.3, and 50% of the tungsten oxide particles of the 8 tungsten oxide particles each had the degree of circularity more than 0.8.

### Acetaldehyde Gas Decomposition Experiment Using Photocatalyst of Comparative Example 1

An acetaldehyde gas decomposition experiment was conducted using the photocatalyst of Comparative Example 1 to evaluate photocatalytic activity. The experimental method and the calculation method of the gas decomposition rate were the same as those of the acetaldehyde gas decomposition experiment using the photocatalyst of Example 1.

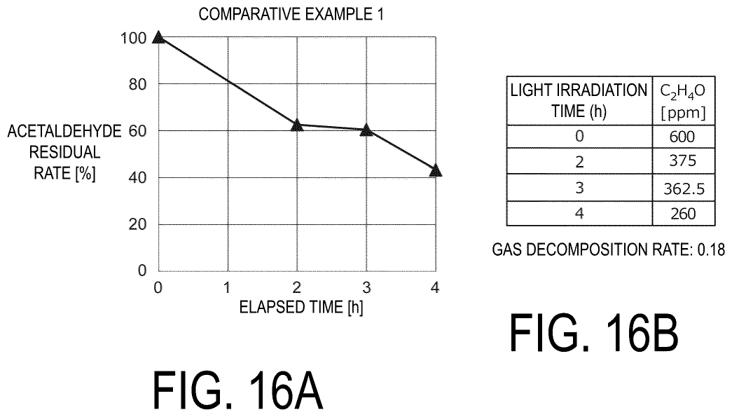

FIG. 16A is a graph showing a change in acetaldehyde residual ratio (%) in an acetaldehyde gas decomposition experiment conducted using the photocatalyst of Comparative Example 1, and FIG. 16B shows a gas decomposition rate calculated using the table showing acetaldehyde concentrations measured in this acetaldehyde gas decomposition experiment and the above equation.

In this experiment, as shown in FIG. 16B, the acetaldehyde gas concentration after light irradiation for 4 hours was 260 ppm, and the gas decomposition rate was 0.18.

1. A visible light responsive photocatalyst comprising:
at least one tungsten oxide particle; and
at least one co-catalyst particle supported on a surface of the tungsten oxide particle,
wherein 20% or more of the co-catalyst particles of a plurality (100 or more) of the co-catalyst particles each of whose primary particle diameter is measurable by an electron microscopic image of the visible light responsive photocatalyst are non-aggregates and each have a primary particle diameter from 6 nm to 20 nm.

2. A visible light responsive photocatalyst comprising:
a tungsten oxide particle; and
a plurality of co-catalyst particles supported on a surface of the tungsten oxide particle,
wherein an average primary particle diameter of a plurality of co-catalyst particles which are non-aggregates each of whose primary particle diameter is measurable by an electron microscopic image of the visible light responsive photocatalyst is from 6 nm to 20 nm.

3. The visible light responsive photocatalyst according to claim 1,
wherein 50% or more of the co-catalyst particles of the plurality (100 or more) of co-catalyst particles each of whose primary particle diameter is measurable by the electron microscope image of the visible light responsive photocatalyst are respectively not in contact with another co-catalyst particle on the tungsten oxide particle supporting the co-catalyst particles.

4. The visible light responsive photocatalyst according to claim 1,
wherein a mass ratio of the plurality of co-catalyst particles to the plurality of tungsten oxide particles is from 0.01 wt % to 2.0 wt %.

5. The visible light responsive photocatalyst according to claim 1,
wherein the co-catalyst particle is a metal particle or metal oxide particle containing at least platinum.

6. The visible light responsive photocatalyst according to claim 1,
wherein 90% or more of the tungsten oxide particles of the plurality (100 or more) of tungsten oxide particles each of whose primary particle diameter is measurable by the electron microscopic image of the visible light responsive photocatalyst each have a primary particle diameter from 5 nm to 400 nm.

7. A visible light responsive photocatalyst comprising:
a tungsten oxide particle; and
a plurality of co-catalyst particles supported on a surface of the tungsten oxide particle,
wherein 50% or more of the tungsten oxide particles of a plurality (100 or more) of the tungsten oxide particles each of whose aspect ratio (ratio (b/a) of a major axis b to a minor axis a of a primary particle) is calculable from an electron microscope image of the visible light responsive photocatalyst each have an aspect ratio from 1.3 to 10.

8. The visible light responsive photocatalyst according to claim 7,
wherein 70% or more of the tungsten oxide particles of the plurality (100 or more) of tungsten oxide particles each of whose degree of circularity is calculable from the electron microscope image of the visible light responsive photocatalyst each have the degree of circularity from 0.2 to 0.8.
